(19) United States
(12) Patent Application Publication
(10) Pub. No.: US 2006/0136539 A1
(43) Pub. Date: Jun. 22, 2006

(54) Data processing device with microprocessor and with additional arithmetic unit and associated method

(75) Inventors: Thomas Behling, Hamburg (DE); Ralf Malzahn, Seevetal (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/537,742

(22) PCT Filed: Nov. 25, 2003
(86) PCT No.: PCT/IB03/05436

§ 371 Date: Jun. 3, 2005

(30) Foreign Application Priority Data
Dec. 4, 2002 (DE) 102 56 586.4

(51) Int. Cl. G06F 7/38

(52) U.S. Cl. 708/490

(57) ABSTRACT

In order to further develop a data processing device (100; 100′) having at least one microprocessor (90) and having at least one additional arithmetic unit (40) as well as a method of performing at least one particular defined calculation by means of the data processing device (100; 100′) in such a way that a plurality of calculations may be performed in sequence without any intervention by the microprocessor (90), it is proposed that the registers be loadable from at least one in particular peripheral memory (10), for example from at least one R[andom]A[ccess]M[emory], from at least one R[ead]O[nly]M[emory] or from at least one E[lectrically] E[rasable] P[rogrammable] R[ead]O[nly]M[emory.

The present invention relates to a data processing device having at least one microprocessor and having at least one additional arithmetic unit and to a method of performing at least one particular defined calculation by means of at least one data processing device of the above-mentioned type.

Such data processing devices, in particular those integrated in a single semiconductor chip, are known in principle, for example from the data sheet for integrated circuit P83C852 made by Philips.

This integrated circuit is fitted, inter alia, in portable card-form data carriers, for example in data carriers in check card format, and serves, for instance, to encrypt data using an asymmetrical encryption method or to decrypt such data. In such instances, inter alia data blocks are exponentiated with a key index modulo a constant, wherein the constant has a high number of digits, in order to achieve the securest possible encryption.

The arithmetic steps required therefor may in principle also be performed by means of the microprocessor; however, this would take too long, such that, in addition to the microprocessor, a special arithmetic unit is integrated into the chip which is of optimum design for the arithmetic steps necessary for encryption. The connection between microprocessor and additional arithmetic unit is achieved in this context by means of special registers controlling data transfer and by means of at least one data storage medium, to which both the microprocessor and the additional arithmetic unit have access.

A disadvantage of these known integrated circuits with microprocessor and additional arithmetic unit is that, after a processing step or a processing cycle has been performed by the additional arithmetic unit, the microprocessor has to reload the registers with new values for at least partially new operands, with which the next processing cycle then starts. This causes a considerable loss of time, such that the overall data processing device requires too much time for data encryption or data decryption, in particular with longer key indices.

So that the arithmetic unit may start the next processing cycle for new data immediately after completion of one processing cycle and as far as possible without time loss, according to the disclosure of EP 0 822 482 A2 the registers are provided as at least two sets of registers to control data transfer and to transmit commands.

In this context, the outputs of these registers are switched over by the content of a further register, such that in each case only one set of registers is active. However, new data may be written at any time by the microprocessor to the inactive register, such that these data are ready when the arithmetic unit has completed a processing cycle and the next processing cycle may begin immediately; in this way, an encryption or decryption-process is speeded up considerably.

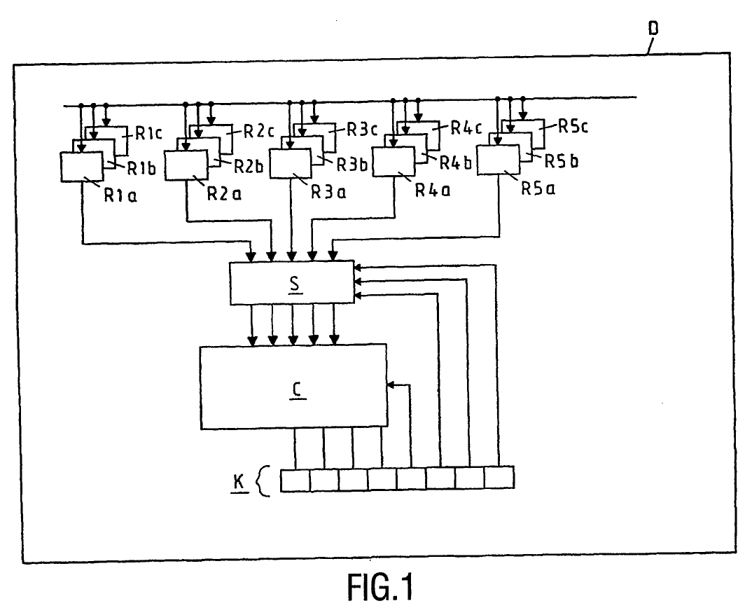

According to the disclosure of EP 0 822 482 A2, initialization of the arithmetic unit C may be speeded up by a plurality of parallel register sets R1, R2, R3, R4, R5 and by a selection circuit S. In this way, the registers may be loaded during one calculation for the following calculation (c.f. FIG. 1, which is a schematic representation of a block diagram of the data processing device D constructed according to EP 0 822 482 A2, in which device D the arithmetic unit C is controlled by three sets a, b, c of registers R1, R2, R3, R4, R5; the reference numeral K denotes the control register).

The respectively active register supplies the input values for the arithmetic unit and must not be changed during calculation. Modification of this register set is thus only possible during the following calculation with another register set or in an interval between two calculations.

The disadvantage of implementing EP 0 822 482 A2 is that each additional register set requires chip surface area, as a function of the size of the register set. Modern cryptographic algorithms are often composed of a number of small quick operations, whereby a large number of register sets is required to enable quick calculation.

Moreover, according to the prior art, the microprocessor must start each individual calculation by asserting a corresponding control bit, which may cause further delay.

Taking as basis the above-described disadvantages and shortcomings and acknowledging the outlined prior art, it is an object of the present invention so to develop a data processing device of the above-mentioned type (c.f. prior art EP 0 822 482 A2) and a method of the above-mentioned type that a number of calculations may be performed in sequence without intervention by the microprocessor.

This object is achieved with a data processing device having the features indicated in claim 1 and by a method having the features indicated in claim 10. Advantageous embodiments and expedient further developments of the present invention are identified in the dependent claims.

According to the teaching of the present invention, the registers for controlling data transfer and for command transmission are loaded from at least one peripheral memory, for example from at least one R[andom]A[ccess]M[emory], from at least one R[ead]O[nly]M[emory] or from at least one E[pectrically] E[rasable] P[rogrammable] R[ead] 0[nly] M[emory]. Therefore, the invention proposes as it were automatic loading of input data sets for a microprocessor with additional arithmetic unit.

According to a particularly inventive further development, at least one additional address register connected to at least one control logic circuit is assigned to the memory, which address register serves, with regard to loading of the registers, as a pointer to the start address of the data to be loaded. At least one counting register, likewise connected to the control logic circuit, preferably indicates the register sets to be loaded in sequence.

Since reloading from the in particular peripheral memory is generally quicker than loading the registers via the microprocessor, according to the invention a large number of operations may be performed in sequence without time being lost between the calculations. This corresponds, according to the invention, with the fact that the input registers are loaded prior to and during calculation, by fetching or loading data from the addressed memory.

Since for the entire calculation (=× individual calculations) only the address register and the counting register are initialized, the code size of the microprocessor is markedly smaller in comparison to the solution with a plurality of register sets lanown from the prior art. The register data may be saved for example as raw data in the program code of the microprocessor.

The above-described data processing device having at least one microprocessor and having at least one additional arithmetic unit serves in performing particular defined calculations, this being effected with the following method steps according to the present invention:

First of all, the two additional registers, i.e. the address register and the counting register, are initialized by the microprocessor and calculation may start by assertion of a control bit. Starting with the start address indicated by the register, the data are loaded from the peripheral memory into a temporary register set. The address register is incremented by one with each access to the memory.

If the temporary register set is full (complete), this temporary register set is transferred into the main register set and then the counting register is reduced by one, and the additional arithmetic unit begins the actual calculation. During this calculation, the next register set is saved from the memory to the temporary register set.

Once the current calculation is terminated, the temporary register set is saved to the main register set, the counting register is reduced by one and the next calculation starts immediately, without the microprocessor having to intervene in any way. This process is repeated until the counting register has been decremented to zero.

According to a preferred further development of the present invention, at least one selection circuit may be connected between the temporary register set and the main register set, such that the invention described here may be combined without difficulty with a development comprising a plurality of sets of registers assigned to the microprocessor. By using the main register set, in which the registers are stored for the active calculation, the active register set may be modified after the start of calculation for the subsequent calculation.

Each addressable memory may advantageously serve as a source for the register data to be loaded (but attention must be paid to conflicts in the event of memory access by other circuit blocks, for example the microprocessor). Provision of at least one M[emory]M[anagement]S[ystem] or at least one M[emory]M[anagement]U[nit] may regulate parallel accesses to a memory. Irrespective thereof or in conjunction therewith, moreover, the option essential to the invention arises of a universal address pointer, by means of which access may be made to a plurality of memory blocks. This additional special function is suitable above all for the above-described address register according to the present invention.

The present invention further relates to a portable data carrier, comprising at least one data processing device of the above-described type.

The present invention finally relates to a semiconductor chip, comprising at least one integrated data processing device of the above-described type.

As already discussed above, there are various possible ways of advantageously embodying and developing the teaching of the present invention. Reference is made, in this regard, to the claims subordinate to claim 1, and the invention will be further described with reference to examples of embodiments shown in the drawings to which, however, the invention is not restricted. In the Figures:

FIG. 1 is a schematic representation of a block diagram of a data processing device, in which the arithmetic unit is controlled by three sets of registers according to the prior art;

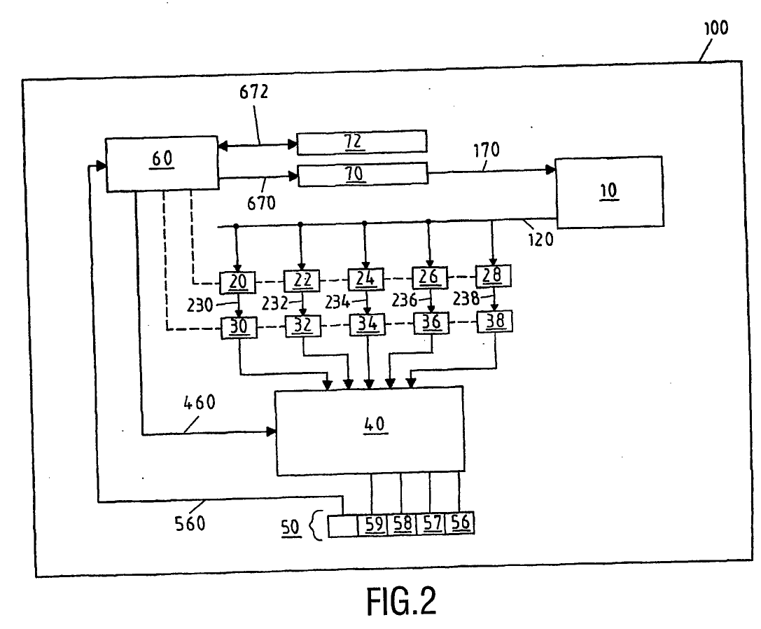

FIG. 2 is a schematic block diagram of a first example of embodiment of a data processing device according to the present invention;

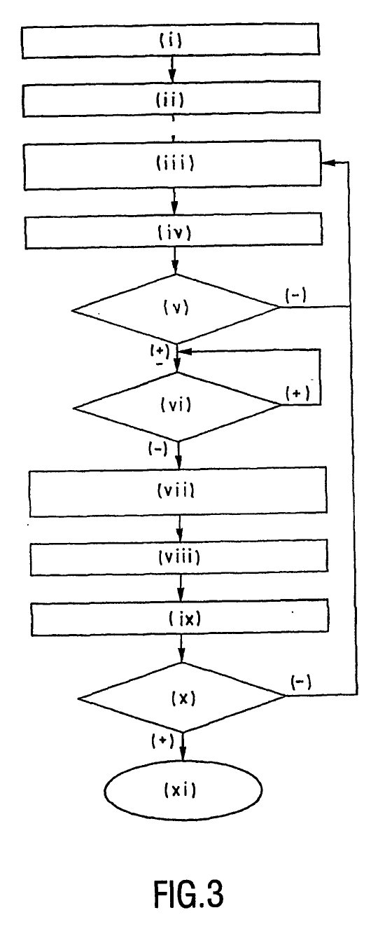

FIG. 3 is a schematic representation of a flow chart for a method associated with the data processing device of FIG. 2 for performing particular defined calculations;

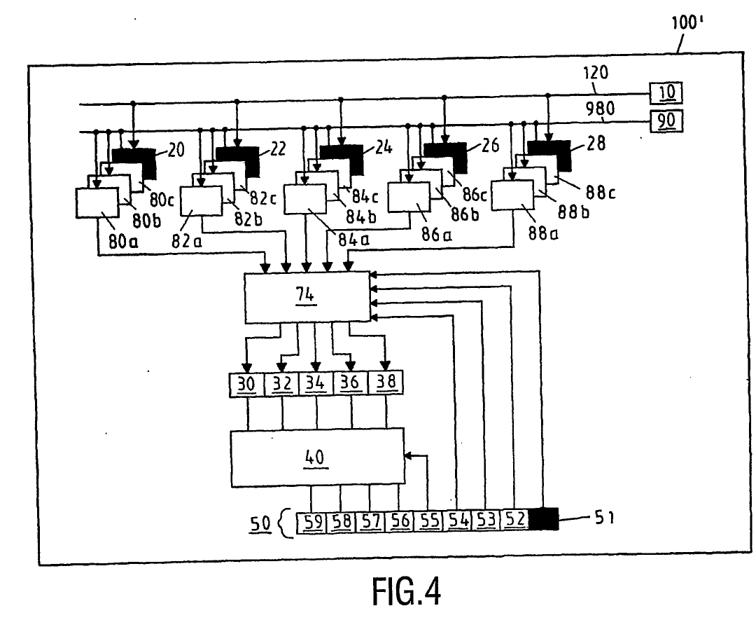

FIG. 4 is a schematic representation of a block diagram of a second example of embodiment of a data processing device, in which the arithmetic unit is controlled by three sets of registers, according to the present invention; and

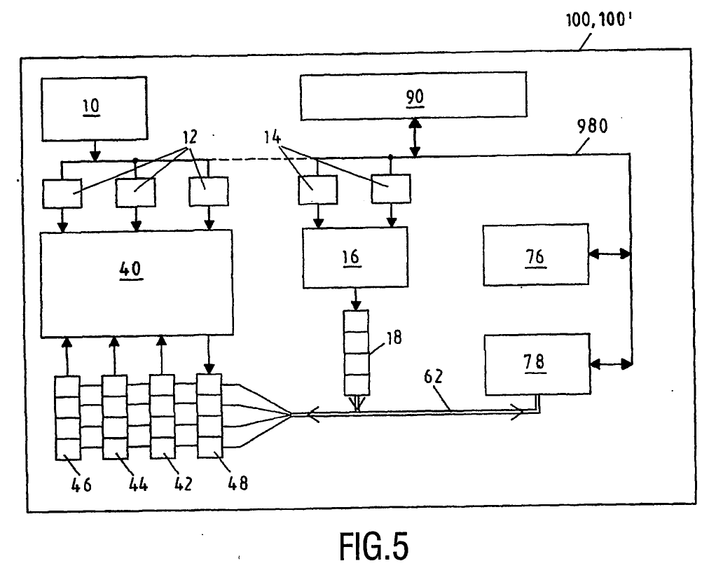

FIG. 5 is a schematic overview of a block diagram of the overall data processing device according to the present invention, in the form of a simplified combination of the first example of embodiment of FIG. 2 and the second example of embodiment of FIG. 4.

Identical or similar embodiments, elements or features are provided with identical reference numerals in FIGS. 2 to 5.

FIG. 2 shows a first example of embodiment of a data processing device 100 with microprocessor 90 and with additional special arithmetic unit 40 for particular calculations, which would be too time-consuming if performed by the microprocessor 90.

The arithmetic unit 40 is coupled with the microprocessor 90 via a number of registers, of which in principle first registers are provided for controlling data transfer and second registers are provided for transmitting commands. In addition, the arithmetic unit 40 is associated with a control register 50 which is connected to the control logic circuit 60.

The special feature of the data processing device 100 according to the first example of embodiment is, inter alia, that the registers may be loaded from a peripheral memory 10 in the form of an E[lectrically]E[rasable]P[rograrnable]R[ead]O[nly]M[emory], thereby providing automatic loading of input data sets for the microprocessor 90 with additional arithmetic unit 40.

As is also clear from the illustration in FIG. 2, an additional address register 70 connected 670 to a control logic circuit 60 is assigned to the peripheral memory 10, which address register 70 serves, with regard to loading of the register, as a pointer to the start address of the data to be loaded, such that the memory 10 may be acted upon by the address register 70 (--> reference numeral 170). In addition, a counting register 72, likewise connected 672 to the control logic circuit 60, indicates the register sets to be loaded in sequence and defines the number of calculations.

With regard to a more precise description of the registers, a set of five temporary registers 20, 22, 24, 26, 28 is assigned to the memory 10, which registers are respectively connected 230, 232, 234, 236, 238 to a set of five main registers 30, 32, 34, 36, 38 assigned to the arithmetic unit 40 and intended for storage of the registers for the active calculation.

Since reloading from the memory 10 is generally quicker than loading the registers via the microprocessor 90, a large number of operations may be performed in sequence with the data processing device 100 according to the first example of embodiment without time being lost between the calculations. Since for the entire calculation (=× individual calculations) only the address register 70 and the counting register 72 are initialized, the code size of the microprocessor 90 is relatively small. The register data may be saved for example as raw data in the program code of the microprocessor 90.

In detail, the above-described data processing device 100 operates, during performance of the particular defined calculations, according to the following method steps illustrated in FIG. 3:

(i) first of all, the two additional registers, i.e. the address register 70 and the counting register 72, are initialized by the microprocessor 90;

(ii) than calculation may start by assertion of a control bit;

(iii) starting with the start address indicated by the register, the data are loaded from the peripheral memory 10 via an internal data bus 120 into a set of temporary registers 20, 22, 24, 26, 28,

(iv) wherein the address register 70 is incremented by one with each access to the memory 10;

(v.a) if the set of temporary registers 20, 22, 24, 26, 28 is full (complete) and

(vi.b) if the arithmetic unit 40 is inactive,

(vii) the set of temporary registers 20, 22, 24, 26, 28 is transferred into the set of main registers 30, 32, 34, 36, 38 and

(viii) then the counting register 72 is reduced by one, and

(ix) the additional arithmetic unit 40 starts the actual calculation; during this calculation, the next register set is saved from the memory 10 to the set of temporary registers 20, 22, 24, 26, 28; once the current calculation is terminated, the set of temporary registers 20, 22, 24, 26, 28 is saved to the set of main registers 30, 32, 34, 36, 38, the counting register 72 is reduced by one and the next calculation starts immediately, without the microprocessor 90 having to intervene in any way;

(x) this process is repeated until the counting register 72 has been decremented to zero,

(xi) whereupon the process is terminated.

The second example of embodiment of a data processing device 100′ according to FIG. 4 differs from the first example of embodiment of a data processing device 100 according to FIG. 2 substantially in that a selection circuit 74 is connected between the set of temporary registers 20, 22, 24, 26, 28 and the set of main registers 30, 32, 34, 36, 38, which selection circuit 74 may be acted upon by bit positions 51, 52, 53, 54 of the control register 50.

Therefore, the first example of embodiment illustrated in FIG. 2 of a data processing device 100 may be extended or combined by using at least one input multiplexer with three sets a, b, c of in each case five registers 80, 82, 84, 86, 88, wherein these register sets 80a, 80b, 80c, 82a, 82b, 82c, 84a, 84b, 84c, 86a, 86b, 86c, 88a, 88b, 88c draw their data via a data bus 980 from the microprocessor 90, whereas, for control of the arithmetic unit 40 by the schematically illustrated registers, a set of five temporary registers 20, 22, 24, 26, 28 draws its particular data via the data bus 120 from the memory 10.

The outputs of all the registers lead to the selection circuit 74, which selects the outputs of one of these sets of registers and feeds them via the set of five main registers 30, 32, 34, 36, 38 to the arithmetic unit 40, wherein selection is controlled by a bit position 51 applied to the temporary register set 20, 22, 24, 26, 28 supplied via the internal data bus 120 with data from the memory 10 or by three bit positions 52, 53, 54 of the control register 50, present in only one instance, applied to the register sets 80a, 80b, 80c, 82a, 82b, 82c, 84a, 84b, 84c, 86a, 86b, 86c, 88a, 88b, 88c supplied via the internal data bus 980 with data from the microprocessor 90.

The inputs of all the registers are connected to an internal data bus intended substantially only for the transfer of data and may be individually selected by the microprocessor 90 for writing, wherein the selection lines have been omitted for the sake of clarity.

The registers 80a, 80b, 80c, 82a, 82b, 82c, 84a, 84b, 84c, 86a, 86b, 86c, 88a, 88b, 88c may each receive one byte of data only from the internal bus and output it only to the selection circuit 40, while the control register 50 may be written and read bit by bit, wherein the bit positions 51, 52, 53, 54, 55 only accept data from the internal data bus and control the selection circuit 74 (--> bit positions 51, 52, 53, 54) and the arithmetic unit 40 (--> bit position 55) via the outputs, while the bit positions 56, 57, 58, 59 are provided for further communication between the arithmetic unit 40 and the microprocessor 90.

Finally, FIG. 5 is a schematic overview of a block diagram of an overall data processing device 100, 100′ according to the present invention in the form of a combination of the first example of embodiment (data processing device 100 according to FIG. 2) and the second example of embodiment (data processing device 100′ according to FIG. 4).

The overall data processing device 100, 100′ comprises inter alia the microprocessor 90 and the additional special arithmetic unit 40 for particular calculations, which would be too time-consuming if performed by the microprocessor 90.

In addition, the overall data processing device 100, 100′ is provided with a volatile memory 16 together with a first write/read memory 76 and a second write/read memory 78. The microprocessor 90 is coupled with the two write/read memories 76, 78 substantially directly via the above-described internal bus 980 (c.f. FIG. 4). Furthermore,

the microprocessor 90 is coupled to the volatile memory 16 via further address registers 14 and

the peripheral memory 10 is coupled to the arithmetic unit 40 via further registers 12.

Although control of the additional arithmetic unit 40 by the further registers 12 illustrated schematically in FIG. 5 is explained more clearly and in detail in the description relating to FIGS. 2, 3 and 4, it should be stated in brief at this point that control signals for controlling functioning of the additional arithmetic unit 40 and for controlling transmission of operands for the arithmetic unit 40 and of results from the arithmetic unit 40 are substantially transmitted via the further registers 12.

The operands themselves are transmitted via operand registers 42, 44, 46 to the arithmetic unit 40, the result coming from the arithmetic unit 40 is transmitted via the result register 48 and in particular via a further internal bus 62, to which data representing the operands are supplied from the volatile memory 16 via a memory register 18 and from the second write/read memory 78.

Moreover, the result of a calculation performed in the arithmetic unit 40 is supplied to the second write/read memory 78 via the bus 62. Since both the additional arithmetic unit 40 and the microprocessor 90 have access to the second write/read memory 78 (via the bus 62 and the data bus 980 respectively), data may also be exchanged via this second write/read memory 78 between the arithmetic unit 40 and the microprocessor 90.

The internal bus 62 serves, as already mentioned, substantially only in the transmission of data. Since the arithmetic unit 40 is also intended to perform operations with operands several bytes long, the data bus 62 is designed for relatively large data widths, for example for four bytes. In this context, it is assumed that the first write/read memory 76 may also output four bytes in parallel, either by appropriate construction or by internal series/parallel conversion, several words of one byte in length being received in series and output in parallel. A corresponding arrangement is indicated in the form of the memory register 18 at the output of the volatile memory 16, which memory register 18 thus passes four bytes supplied in series on in parallel via the bus 62.

The three operand registers 42, 44, 46 are so designed that they may receive four bytes in parallel and output them in parallel or optionally in smaller portions of less than four bytes, depending on which word length the additional arithmetic unit 40 is able to process. Again depending on the structure of the arithmetic unit 40, the result register 48 for the arithmetic results may receive several bytes in series or in parallel and in each case transmit four bytes in parallel via the internal bus 62.

Transmission of the addresses from the additional arithmetic unit 40 for the volatile memory 16 and for the first write/read memory 76 is not illustrated in any more detail in FIG. 5 for reasons of clarity, since addressing of memories is well known to the person skilled in the art.

Finally, it should be noted with regard to the present invention that the five registers (c.f. FIGS. 2 and 4), which are present in each set of registers, may serve the following purposes for example:

containing the operation codes for controlling the arithmetic unit 40;

stating the start address for the first operand;

containing the start address for the second operand;

containing the address for a further operand, which is processed in various ways in the arithmetic unit 40 as a function of the operation to be performed with the arithmetic unit 40; for example the operand which is stated by this address constitutes the modulus in modulo operations;

containing an address for the arithmetic result of the arithmetic unit 40;

stating the length of the first operand; and/or

stating the length of the second operand.

The arrangement described according to FIG. 2 (=first example of embodiment), according to FIG. 4 (=second example of embodiment) and according to FIG. 5 (=simplified combination of first example of embodiment and second example of embodiment) allows the computing power of the arithmetic unit 40 to be optimally exploited, since, during performance of a calculation using a first set of registers, the microprocessor 90 may load the registers of a further set with new values and, when the arithmetic unit 40 has completely processed a set of operands and output the result, the microprocessor 90 may with one step change the content of the bit positions 51, 52, 53, 54 of the control register 50, such that the addresses for new operands may immediately be valid and calculation with these operands may start immediately with a waiting period. Stating the operand address by start address and operand length allows very simple, rapid and register-saving addressing of the operands.

### LIST OF REFERENCE NUMERALS

100 Data processing device (first example of embodiment; FIG. 2)
100′ Data processing device (second example of embodiment; FIG. 4)
10 Memory, in particular peripheral
12 Further registers
14 Further address registers
16 Volatile memory
18 Memory register
20 First temporary register
22 Second temporary register
24 Third temporary register
26 Fourth temporary register
28 Fifth temporary register
20 First main register
32 Second main register
34 Third main register
36 Fourth main register
38 Fifth main register
40 (Additional) arithmetic unit
42 First operand register
44 Second operand register
46 Third operand register
48 Result register
50 Control register
51 First bit position of the control register 50
52 Second bit position of the control register 50
53 Third bit position of the control register 50
54 Fourth bit position of the control register 50
55 Fifth bit position of the control register 50
56 Sixth bit position of the control register 50
57 Seventh bit position of the control register 50
58 Eighth bit position of the control register 50
59 Ninth bit position of the control register 50
60 Control logic circuit
62 Internal (operand) bus
70 Address register
72 Counting register
74 Selection circuit
76 First write/read memory
78 Second write/read memory
80 First register assigned to the microprocessor 90
82 Second register assigned to the microprocessor 90
84 Third register assigned to the microprocessor 90
86 Fourth register assigned to the microprocessor 90
88 Fifth register assigned to the microprocessor 90
90 Microprocessor
120 Data bus from memory 10 to temporary registers 20, 22, 24, 26, 28
170 Action of address register 70 on memory 10
230 Connection between first temporary register 20 and first main register 30
232 Connection between second temporary register 22 and second main register 32
234 Connection between third temporary register 24 and third main register 34
236 Connection between fourth temporary register 26 and fourth main register 36
238 Connection between fifth temporary register 28 and fifth main register 38
460 Connection between arithmetic unit 40 and control logic circuit 60
560 Connection between control register 50 and control logic circuit 60
670 Connection between control logic circuit 60 and address register 70
672 Connection between control logic circuit 60 and counting register 72
980 Internal data bus from microprocessor 90 to registers 80, 82, 84, 86, 88
C Arithmetic unit according to the prior art
D Data processing device according to the prior art
K Control register according to the prior art
R1 First register according to the prior art
R2 Second register according to the prior art
R3 Third register according to the prior art
R4 Fourth register according to the prior art
R5 Fifth register according to the prior art
S Selection circuit according to the prior art

1. A data processing device having at least one microprocessor and having at least one additional arithmetic unit for performing at least one particular defined calculation, the arithmetic unit being coupled to the microprocessor via a number of registers, of which first registers are provided for controlling the data transfer and second registers are provided for transmitting commands, characterized in that the registers may be loaded from at least one particularly peripheral memory, for example
from at least one R[andom]A[ccess]M[emory],
from at least one R[ead]O[nly]M[emory] or
from at least one E[lectrically] E[rasable] P[rogrammable] R[ead] O[nly] M[emory].

2. A data processing device as claimed in claim 1, characterized in that at least one set of temporary registers is assigned to the memory, which set of registers is connected to at least one set of main registers assigned to the arithmetic unit (and intended for storage of the registers for the active calculation.

3. A data processing device as claimed in claim 1, characterized in that the memory may be acted upon by at least one address register intended for pointing to the start address of the data to be loaded, which address register is connected to at least one control logic circuit.

4. A data processing device as claimed in claim 3, characterized in that assigned to the arithmetic unit is at least one control register, which is connected to the control logic circuit.

5. A data processing device as claimed in claim 3, characterized in that at least one counting register for indicating the register sets to be loaded in sequence is assigned to the control logic circuit.

6. A data processing device as claimed in claim 1, characterized in that at least one selection circuit is connected between the set of temporary registers and the set of main registers, for combination with at least one set of registers assigned to the microprocessors.

7. A data processing device as claimed in claim 6, characterized in that the selection circuit may be acted upon by at least one bit position of the control register.

8. A portable data carrier having at least one data processing device as claimed in claim 1.

9. A semiconductor chip comprising at least one integrated data processing device as claimed in claim 1.

10. A method of performing at least one particular defined calculation by means of at least one data processing device having at least one microprocessor and having at least one additional arithmetic unit, characterized by the following method steps:
(i) initialization of at least one address register and at least one counting register by the microprocessors;
(ii) starting of the calculation by assertion of at least one control bit;
(iii) copying or loading of data beginning at the start address from at least one in particular peripheral memory into at least one set of temporary registers;
(iv) incrementation of the address register with each access to the memory;
(v) establishing whether the set of temporary registers is complete:
(v.a) if the set of temporary registers is complete (+), proceeding to method step (vi);
(v.b) if the set of temporary registers is incomplete (−), proceeding to method step (iii);
(vi) establishing whether the arithmetic unit is active:
(vi.a) if the arithmetic unit is active (+), proceeding to method step (vi);
(vi.b) if the arithmetic unit is inactive (−), proceeding to method step (vii);
(vii) copying or transferal of data from the set of temporary registers into at least one set of main registers;
(viii) decrementation of the counting register;
(ix) starting of the calculation in the arithmetic unit;
(x) establishing whether the counting register has been decremented to zero:
(x.a) if the counting register has been decremented to zero (+), proceeding to method step (xi);
(x.b) if the counting register has not been decremented to zero (−), proceeding to method step (iii);
(xi) termination.
